(19) United States
(12) Patent Application Publication
(10) Pub. No.: US 2024/0157558 A1
(43) Pub. Date: May 16, 2024

(54) ROBOT CONTROL SYSTEM, ROBOT CONTROL METHOD, AND NON-TRANSITORY COMPUTER READABLE MEDIUM

(71) Applicant: NEC Corporation, Tokyo (JP)

(72) Inventor: Yoshimi KOMUKAI, Tokyo (JP)

(73) Assignee: NEC Corporation, Tokyo (JP)

(21) Appl. No.: 18/385,493

(22) Filed: Oct. 31, 2023

(30) Foreign Application Priority Data
Nov. 16, 2022 (JP) 2022-183046

(51) Int. Cl. B25J 9/16

(52) U.S. Cl. CPC B25J 9/1666

(57) ABSTRACT

A robot control system, a robot control method, and a robot control program by which a robot can be operated more efficiently are provided. A robot control system according to the present disclosure is a system for controlling a robot that executes a plurality of tasks. The robot control system includes an acquisition unit and a control unit. The acquisition unit acquires position information indicating a transition of positions of the robot in the first task plan. The control unit determines whether or not each of the positions of the robot that is executing the first task specified by the position information interferes with execution of a process of acquiring environmental information for generating the second task plan, to thereby determine a timing at which the process of acquiring environmental information is executed.

### INCORPORATION BY REFERENCE

This application is based upon and claims the benefit of priority from Japanese patent application No. 2022-183048, filed on Nov. 16, 2022, the disclosure of which is incorporated herein in its entirety by reference.

### TECHNICAL FIELD

The present disclosure relates to a robot control system, a robot control method, and a non-transitory computer readable medium.

### BACKGROUND ART

In recent years, in order to solve a labor shortage in warehouses and factories, robots that carry out automatic loading and unloading have been developed. Japanese Unexamined Patent Application Publication No. 2019-025566 discloses a picking robot by which a working time required for warehouse work can be reduced. The picking robot performs an operation of taking a plurality of articles out of a carry-in box and storing them in a storage box. After the picking robot has taken out one article, the picking robot captures an image of the carry-in box and recognizes a target article for the next storage operation. Then, the picking robot makes an execution plan and takes out the next article.

In the above-described picking robot disclosed in Japanese Unexamined Patent Application Publication No. 2019-025566, it is not possible to capture an image of the carry-in box until after one article has been taken out. Therefore, it is not possible for the picking robot to recognize the target article during execution of the operation, and thus it is not enough to efficiently operate the robot.

### SUMMARY

In view of the problem described above, an object of the present disclosure is to provide a robot control system, a robot control method, and a non-transitory computer readable medium by which a robot can be operated more efficiently.

A robot control system according to the present disclosure is a robot control system for a robot that executes a plurality of tasks including a first task and a subsequent second task respectively based on a first task plan and a second task plan, the robot control system including:
an acquisition unit configured to acquire position information indicating a transition of positions of the robot in the first task plan; and
a control unit configured to determine whether or not each of the positions of the robot that is executing the first task specified by the position information interferes with execution of a process of acquiring environmental information for generating the second task plan, to thereby determine a timing at which the process of acquiring the environmental information is executed.

A robot control method according to the present disclosure is a method for controlling a robot that executes a plurality of tasks including a first task and a subsequent second task respectively based on a first task plan and a second task plan, the robot control method including:
acquiring position information indicating a transition of positions of the robot in the first task plan;
determining whether or not each of the positions of the robot that is executing the first task specified by the position information interferes with execution of a process of acquiring environmental information for generating the second task plan; and
determining a timing at which the process of acquiring the environmental information is executed based on a result of the determination.

A non-transitory computer readable medium according to the present disclosure is a non-transitory computer readable medium storing a program for a robot that executes a plurality of tasks including a first task and a subsequent second task respectively based on a first task plan and a second task plan, the program causing a computer to execute processing of:
acquiring position information indicating a transition of positions of the robot in the first task plan; and
determining whether or not each of the positions of the robot that is executing the first task specified by the position information interferes with execution of a process of acquiring environmental information for generating the second task plan; and
determining a timing at which the process of acquiring the environmental information is executed based on a result of the determination.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing a configuration of a robot control system according to the present disclosure;

FIG. 2 is a flowchart showing a flow of a robot control method according to the present disclosure;

FIG. 3 is a block diagram showing a configuration of a robot control system according to the present disclosure;

FIG. 4 is a diagram showing an example of movement of a robot controlled by the robot control system according to the present disclosure;

FIG. 5 is a diagram showing a period during which environmental information can be acquired and a next task plan generation period in a task plan shown in Table 1;

FIG. 6 is a diagram showing movement of a robot controlled by the robot control system according to the present disclosure;

FIG. 7A is a diagram showing objects to be included in environmental information captured by a robot controlled by the robot control system according to the present disclosure; and

FIG. 7B is a diagram showing objects to be included in environmental information captured by a robot controlled by the robot control system according to the present disclosure.

### EXAMPLE EMBODIMENT

The present disclosure will be described hereinafter through example embodiments. However, the following example embodiments are not intended to limit the scope of the disclosure according to the claims. Further, all the components described in the example embodiments are not necessarily essential as means for solving the problem. The same elements are denoted by the same reference numerals or symbols throughout the drawings, and redundant descriptions are omitted as necessary. Note that it is needless to say that right-handed xyz orthogonal coordinates shown in the drawings are merely for convenience of describing the positional relation of the components. Normally, a z-axis positive direction is vertically upward and a xy plane is a horizontal plane.

### First Example Embodiment

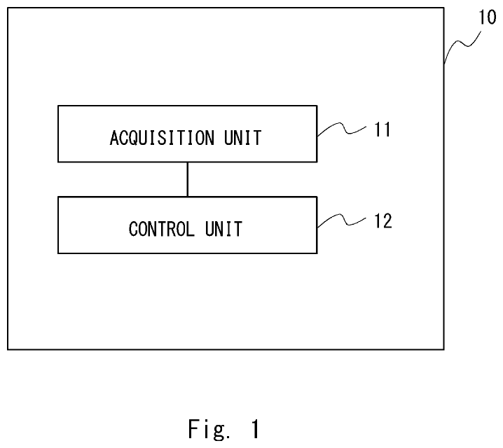

A robot control system according to the present disclosure will be described below with reference to the drawings. FIG. 1 is a block diagram showing a configuration of the robot control system according to the present disclosure. A robot control system 10 according to the present disclosure includes an acquisition unit 11 and a control unit 12.

The robot control system 10 is a system for controlling a robot that executes a plurality of tasks including a first task and a subsequent second task respectively based on a first task plan and a second task plan. Examples of the tasks include work for conveying loads in a warehouse, and work for loading and unloading parts and work for assembling parts in a factory.

The acquisition unit 11 acquires position information indicating a transition of positions of the robot in the first task plan. In the task plan, for example, positions of the robot where the robot should be located each second are shown, and when processes are sequentially executed, the position of the robot transitions from second to second, whereby the task can be executed. The task plan is generated based on environmental information of an area near a robot.

The control unit 12 determines whether or not each of the positions of the robot that is executing the first task specified by the position information interferes with execution of a process of acquiring environmental information for generating the second task plan, to thereby determine a timing at which the process of acquiring environmental information is executed. The environmental information is information about objects included in an area near the robot, which information is required to generate a task plan. For example, in the case of loading/unloading work in which parts are taken out of a carry-in box and stored in a storage box, objects included in environmental information are the parts, the carry-in box, and the storage box. Further, as will be described later, when the robot executes a task of conveying a workpiece to a destination while avoiding an obstacle, objects included in environmental information are the workpiece, the starting region, the obstacle, and the destination.

The environmental information is, for example, information such as a position, a shape, a color, and a pattern of an object included in an area near the robot.

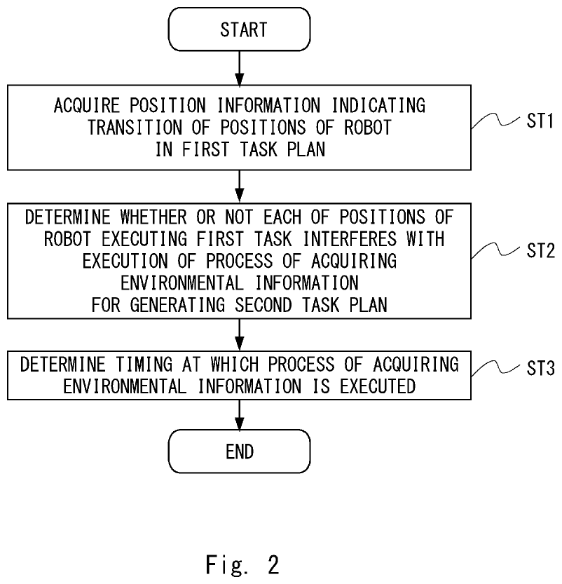

Next, a robot control method according to the present disclosure will be described. FIG. 2 is a flowchart showing a flow of the robot control method according to the present disclosure. First, position information indicating a transition of positions of a robot in a first task plan is acquired (ST1). Next, it is determined whether or not each of the positions of the robot that is executing the first task specified by the position information interferes with execution of a process of acquiring environmental information for generating a second task plan (ST2). Next, a timing at which the process of acquiring environmental information is executed is determined based on a result of the determination (ST3).

As described above, the robot control system according to the present disclosure determines whether or not the positions of the robot task in the first task plan interfere with execution of a process of acquiring environmental information for generating the second task plan, to thereby determine a timing at which the process of acquiring environmental information is executed. By doing so, even when a task is being executed, information required for a next task plan can be acquired and then the next task plan can be performed. Therefore, a stop time between tasks can be eliminated. As a result, since the robot can continuously execute tasks, the takt time and the lead time can be reduced, and thus the robot can be operated more efficiently.

### Second Example Embodiment

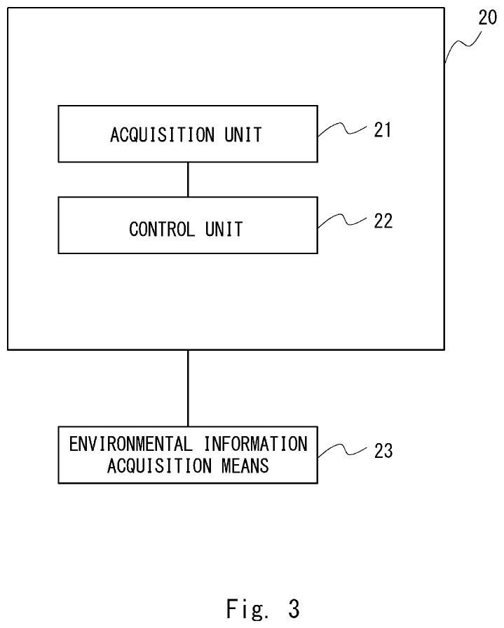

A robot control system according to the present disclosure will be described below with reference to the drawings. FIG. 3 is a block diagram showing a configuration of a robot control system according to the present disclosure. A robot control system 20 according to the present disclosure includes an acquisition unit 21 and a control unit 22. The robot control system according to the present disclosure is connected wirelessly or by wire to environmental information acquisition means 23.

The robot control system 20 according to the present disclosure is a modified example of the control unit 12 of the robot control system 10 shown in FIG. 1. Since the acquisition unit 21 is similar to the acquisition unit 11 of the robot control system shown in FIG. 1, the descriptions thereof will be omitted. In the following description, an example of movement of a robot will be described, and then the control unit 22 and the environmental information acquisition means 23 will be described in detail.

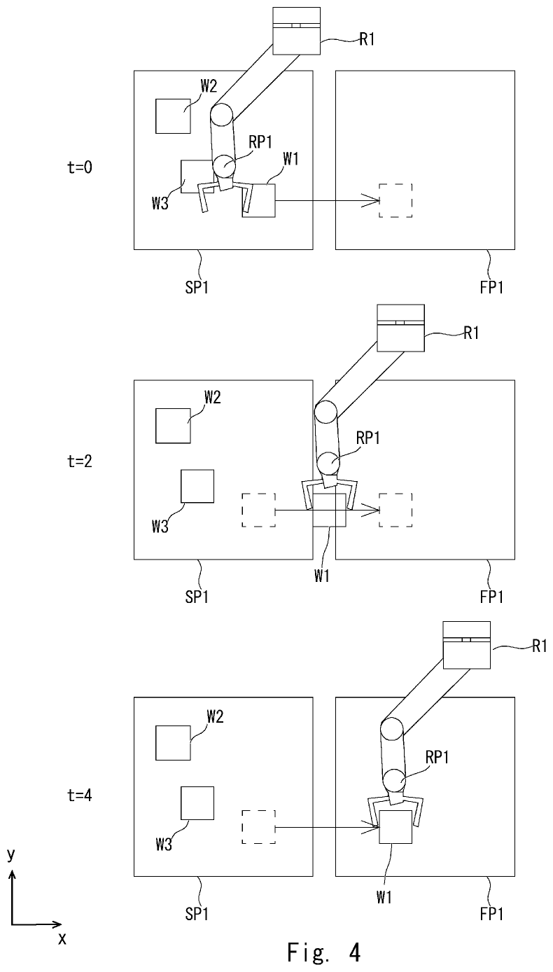

First, an example of movement of a robot controlled by the robot control system 20 according to the present disclosure will be described with reference to FIG. 4. FIG. 4 is a diagram showing an example of movement of a robot controlled by the robot control system according to the present disclosure.

A robot R1 is executing a task of picking up workpieces W1, W2, and W3 using a picking unit RP1 and moving them from a carry-in box SP1 to a storage box FP1. In the example shown in FIG. 4, the robot is moving only the workpiece W1 from the carry-in box SP1 to the storage box FP1 in a single task. That is, each of the workpieces W1, W2, and W3 is moved by the robot in a respective single task. However, the present disclosure is not limited thereto, and all the workpieces W1, W2, and W3 may be moved in a single task. FIG. 4 shows the movement of the robot at the 0th, 2nd, and 4th seconds in a task of moving the workpiece W1 from the carry-in box SP1 to the storage box FP1.

When the robot R1 picks up the workpiece W1 using the picking unit RP1 and moves it from the carry-in box SP1 to the storage box FP1, the robot R1 executes the task in accordance with a task plan. Table 1 shows a task plan when the robot shown in FIG. 4 picks up the workpiece W1 using the picking unit RP1 and moves it from the carry-in box SP1 to the storage box FP1. The example of the task plan in Table 1 shows position information about the position where the picking unit RP1 should be located each second in the seven-second period during which the task is executed. When the robot executes the processes sequentially from the process at the 0th second to the process at the 7th second, the position of the picking unit RP1 transitions from second to second, whereby the task can be executed.

TABLE 1

| | Robot position coordinates | | |
|---|---|---|---|
| Time(s) | x | y | z |
| 0 | 8 | 2.5 | 2 |
| 1 | 8.5 | 2.5 | 3 |
| 2 | 10 | 2.5 | 4 |
| 3 | 12 | 2.5 | 3 |
| 4 | 13.5 | 2.5 | 2 |
| 5 | 12 | 2.5 | 3 |
| 6 | 10 | 2.5 | 4 |
| 7 | 8 | 2.5 | 2 |

Although the example of the task plan in Table 1 shows the position information of the picking unit RP1, it may include information indicating a position of the posture of the arm of the robot R1 and ON/OFF information about the picking function in the picking unit RP1.

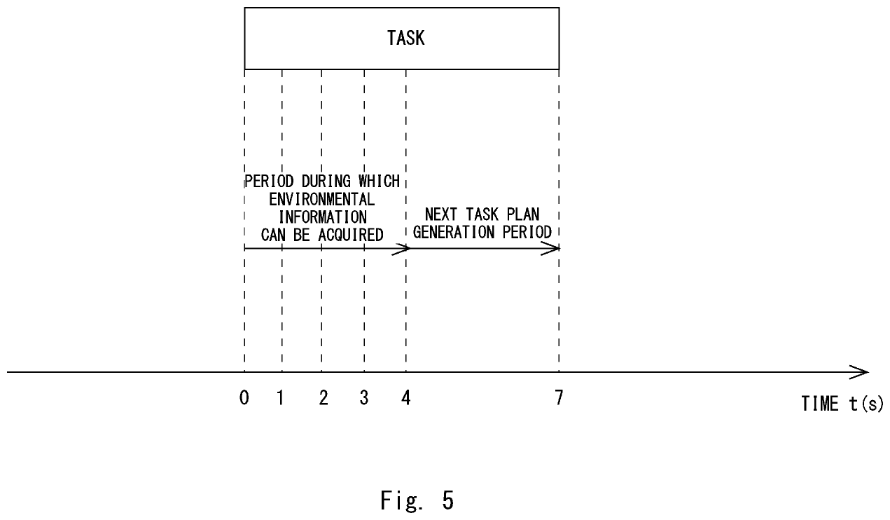

A period during which environmental information can be acquired and a next task plan generation period will be described below with reference to Table 1 and FIG. 5. FIG. 5 is a diagram showing a period during which environmental information can be acquired and a next task plan generation period in a task plan shown in Table 1. In the example shown in FIG. 5, the next task plan generation period is a period from the 4th second to the 7th second in a task plan execution time from the 0th second to the 7th second. Therefore, a period from the 0th second to the 4th second in the task plan execution time from the 0th second to the 7th second is the period during which environmental information can be acquired. That is, a time obtained by subtracting the next task plan generation period from the task plan execution time is the period during which environmental information can be acquired.

Next, the control unit 22 and the environmental information acquisition means 23 will be described. The control unit 22 determines a period during which the position of the robot that is executing the first task does not interfere with execution of a process of acquiring environmental information for generating the second task plan as a timing at which the process of acquiring the environmental information is executed. The environmental information acquisition means 23 executes the process of acquiring environmental information based on the timing at which the process of acquiring environmental information is executed determined by the control unit 22. For example, the environmental information acquisition means 23 executes a process of acquiring the position, the color, and the shape of an object included in the environmental information by using a laser. However, the environmental information acquisition means 23 may execute the process of acquiring the position, the color, and the shape of an object included in the environmental information by capturing an image using a camera.

Further, when the environmental information acquisition means 23 is a camera, whether or not each of the positions of the robot that is executing the first task specified by the position information interferes with execution of a process of acquiring environmental information for generating the second task plan depends on whether or not the robot overlaps an object included in the environmental information and thus interferes with capturing of the object.

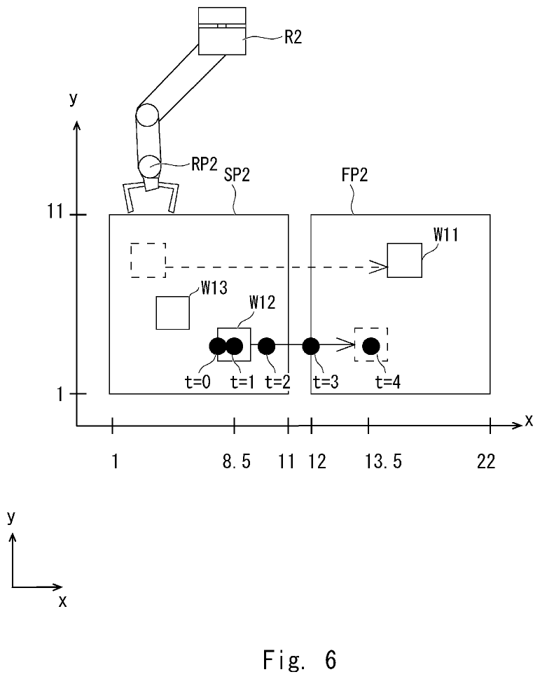

Next, a method for determining a timing at which a process of acquiring environmental information by the control unit 22 will be described in detail with reference to FIG. 6 and Tables 2, 3, and 4.

FIG. 6 is a diagram showing movement of a robot controlled by the robot control system according to the present disclosure. In the example shown in FIG. 6, a robot R2 is executing a task of picking up workpieces W11, W12, and W13 using a picking unit RP2 and moving them from a carry-in box SP2 to a storage box FP2. The robot R2 is executing a task of moving the workpieces W11, W12, and W13 from the carry-in box SP2 to the storage box FP2 in the order of the workpieces W11, W12, and W13. Further, the robot R2 is executing a task of moving one workpiece in a single task. In the example shown in FIG. 6, objects included in environmental information are the workpiece W11, W12, and W13, the carry-in box SP2, and the storage box FP2.

In the example shown in FIG. 6, the robot R2 is executing the second round of the task. That is, FIG. 6 shows an example in which the robot R2 has finished the first round of the task, which is the task of moving the workpiece W11, and is executing the second round of the task, which is the task of moving the workpiece W12.

Note that the second round of the task, in which the robot R2 moves the workpiece W12, corresponds to the first task. Further, the third round of the task, in which the robot R2 moves the workpiece W13, corresponds to the second task. Further, the following description assumes that when the robot R2 is executing the first round of the task, the environmental information required for a plan for the second round of the task is acquired and then the plan for the second round of the task is generated.

First, the acquisition unit acquires position information indicating a transition of positions of the robot R2 in the first task (the second round of the task) plan. Table 2 shows the task plan for the first task (the second round of the task) of the robot R2 shown in FIG. 6. When the robot R2 executes the processes sequentially from the process at the 0th second to the process at the 7th second shown in Table 2, the position of the picking unit RP2 transitions from second to second, whereby the task can be executed. Note that, in the first task plan execution time from the 0th second to the 7th second, a period from the 4th second to the 7th second is the second task (the third round of the task) plan generation period and a period from the 0th second to the 4th second is the period during which environmental information can be acquired. In the following description, the period during which environmental information can be acquired, which is a period from the 0th second to the 4th second, is focused on.

TABLE 2

| | Robot position coordinates | | |
|---|---|---|---|
| Time(s) | x | y | z |
| 0 | 8 | 2.5 | 2 |
| 1 | 8.5 | 2.5 | 3 |
| 2 | 10 | 2.5 | 4 |
| 3 | 12 | 2.5 | 3 |
| 4 | 13.5 | 2.5 | 2 |
| 5 | 12 | 2.5 | 3 |
| 6 | 10 | 2.5 | 4 |
| 7 | 8 | 2.5 | 2 |

The first task (the second round of the task) plan shown in Table 2 is created based on the environmental information acquired when the first round of the task is being executed. Table 3 shows information indicating the positions of the objects included in the environmental information required for the first task (the second round of the task) plan acquired when the first round of the task is being executed. That is, the first task (the second round of the task) plan shown in Table 2 is created based on the environmental information shown in Table 3. Further, arrows shown in FIG. 6 show the position transition of the picking unit RP2 in the first task (the second round of the task) plan shown in Table 2.

TABLE 3

| Object | x | y | z |
|---|---|---|---|
| Workpiece W12 | 8-9 | 2-3 | 0-2 |
| Workpiece W13 | 3-4 | 3-4 | 0-2 |
| SP2 | 1-11 | 1-11 | 0-2 |
| FP2 | 12-22 | 1-11 | 0-2 |

When the first task (the second round of the task) is being executed, the control unit determines a timing at which a process of acquiring environmental information required for the second task (the third round of the task) plan. More specifically, the control unit compares Table 2 with Table 3 and then creates Table 4. Table 4 shows whether or not it is possible to acquire environmental information required for the second task (the third round of the task) plan in the period from the 0th second to the 4th second during which the first task (the second round of the task) is executed. For example, since the position of the picking unit RP2 shown in Table 2 does not overlap the position of the workpiece W13 shown in Table 3 at the 0th second, information about the workpiece W13 can be acquired. On the other hand, since the position of the picking unit RP2 shown in Table 2 overlaps the position of the carry-in box SP2 shown in Table 3 at the 0th second, information about the carry-in box SP2 cannot be acquired.

TABLE 4

| | Object | | |
|---|---|---|---|
| Time(s) | Workpiece W13 | SP2 | FP2 |
| 0 | ∘ | x | ∘ |
| 1 | ∘ | x | ∘ |
| 2 | ∘ | x | ∘ |
| 3 | ∘ | ∘ | x |
| 4 | ∘ | ∘ | x |

As shown in Table 4, the control unit 22 determines whether or not each of the positions of the robot that is executing the first task (the second round of the task) interferes with execution of a process of acquiring environmental information for generating the second task (the third round of the task) plan. The control unit 22 determines a timing at which the process of acquiring environmental information is executed based on a result of the determination (Table 4).

That is, during the execution of the first task (the second round of the task), the control unit 22 assumes that an object included in environmental information is at the position obtained during the execution of the first round of the task and then determines whether or not the position of the picking unit RP2 interferes with execution of a process of acquiring environmental information required for the second task (the third round of the task) plan.

In the example shown in Table 4, the position of the robot R2 does not overlap the position of the workpiece W13 at any timing in the period from the 0th second to the 4th second. Therefore, the control unit determines the period from the 0th second to the 4th second as a timing at which a process of acquiring information about the workpiece W13 is executed.

Further, in the example shown in Table 4, the position of the robot R2 does not overlap the position of the carry-in box SP2 after the 3rd second in the period from the 0th second to the 4th second. Therefore, the control unit determines the 3rd second and the 4th second as timings at which a process of acquiring information about the carry-in box SP2 is executed.

Further, in the example shown in Table 4, the position of the robot R2 does not overlap the position of the storage box FP2 at any timing in the period from the 0th second to the 2nd second. Therefore, the control unit determines the period from the 0th second to the 2nd second as a timing at which a process of acquiring information about the storage box FP2 is executed.

As described above, the control unit determines a period during which the position of the robot that is executing the first task (the second round of the task) does not interfere with execution of a process of acquiring environmental information for generating the second task (the third round of the task) plan as a timing at which the process of acquiring environmental information is executed. By the above configuration, even when a task is being executed, information required for a next task plan can be acquired and then the next task plan can be performed.

Note that a plan for the first round of the task is created by referring to data about the workpiece W11, SP2, and FP2 input in advance. The data about the workpiece W11, SP2, and FP2 input in advance is information including positions, shapes, colors, and patterns thereof. For example, when the environmental information acquisition means 23 is a camera, the shape and the color in the input data are compared with the shape and the color in the image acquired by the camera and then the workpiece having the same color and shape is determined. By doing so, the position coordinates of the workpiece are acquired and then the plan for the first round of the task is created. As another example, the position information in the input data is acquired as it is and then the plan for the first round of the task may be created.

Further, the control unit can preferentially determine a later timing in a period when the robot executing the first task is at a position that does not interfere with execution of a process of acquiring environmental information for generating the second task plan as a timing at which the process of acquiring environmental information is executed.

In the example shown in Table 4, the position of the robot does not overlap the position of the workpiece at any timing in the period from the 0th second to the 4th second. Therefore, the control unit determines the 4th second, which is the later timing in the period from the 0th second to the 4th second, as a timing at which a process of acquiring information about the workpiece is executed.

Further, in the example shown in Table 4, the position of the robot does not overlap the position of the carry-in box SP2 after the 3rd second in the period from the 0th second to the 4th second. Therefore, the control unit determines the 4th second, which is the later timing in the 3rd second and 4th second, is a timing at which a process of acquiring information about the carry-in box SP2 is executed.

Further, in the example shown in Table 4, the position of the robot R2 does not overlap the position of the storage box FP2 at any timing in the period from the 0th second to the 2nd second. Therefore, the control unit determines the 2nd second, which is the later timing in the period from the 0th second to the 2nd second, as a timing at which a process of acquiring information about the storage box FP2 is executed.

In this example, the control unit determines the latest timing in a period when the robot is at a position that does not interfere with execution of a process of acquiring environmental information for generating the second task plan as a timing at which the process of acquiring environmental information is executed. However, the present disclosure is not limited thereto, and any timing may be used if it is a later timing in a period when the robot is at a position that does not interfere with execution of a process of acquiring environmental information for generating the second task plan. For example, in the example shown in Table 4, the control unit may determine the 3rd second in the period from the 0th second to the 4th second as a timing at which a process of acquiring information about the workpiece W13 is executed.

In this way, the control unit can preferentially determine a later timing in a period when the robot is at a position that does not interfere with execution of a process of acquiring environmental information for generating the second task plan as a timing at which the process of acquiring environmental information is executed. By the above configuration, for example, a period in which a change in the environment, such as a shift in the position due to a person coming into contact with an object included in environmental information for generating the second task plan, can be considered increases.

As described above, the robot control system according to the present disclosure determines a period during which the position of the robot that is executing the first task does not interfere with execution of a process of acquiring environmental information for generating the second task plan as a timing at which the process of acquiring the environmental information is executed. By doing so, even when a task is being executed, information required for a next task plan can be acquired and then the next task plan can be performed. Therefore, a stop time between tasks can be eliminated. As a result, since the robot can continuously execute tasks, the takt time and the lead time can be reduced, and thus the robot can be operated more efficiently.

### Third Example Embodiment

A robot control system according to the present disclosure will be described below with reference to the drawings. The robot control system according to the present disclosure includes an acquisition unit and a control unit. The robot control system according to the present disclosure is a modified example of the control unit 12 of the robot control system 10 shown in FIG. 1. Since the acquisition unit of the robot control system according to the present disclosure is similar to the acquisition unit 11 of the robot control system shown in FIG. 1, the descriptions thereof will be omitted. Further, a process of acquiring environmental information performed by the robot control system according to the present disclosure is a process of capturing an image. An object subjected to a process of capturing an image thereof performed by the control unit and determination as to a timing at which the process of capturing the image will be described below.

The control unit determines whether or not each of the positions of the robot that is executing the first task specified by position information overlaps an object included in environmental information for generating the second task plan and thus interferes the capturing of the object. The control unit determines a timing at which a process of acquiring the environmental information is executed based on a result of the determination.

Note that objects included in environmental information include a plurality of types of objects. For example, when a robot conveys a workpiece from a starting region to a destination while avoiding an obstacle, objects included in environmental information are the workpiece, the starting region, the obstacle, and the destination. In this case, the objects included in the environmental information include any one, two, or three of the workpiece, the starting region, the obstacle, and the destination, or all of them.

When the control unit determines that it is possible to acquire the environmental information about one of the plurality of types of objects, the control unit may determine the timing at which the control unit determines that it is possible to acquire the environmental information about one of the plurality of types of objects as a timing at which a process of acquiring the environmental information is executed. The descriptions will be given in more detail with reference to Table 5. Table 5 shows whether or not it is possible to capture images of the workpiece, the starting region, the obstacle, and the destination required for the second task plan in the period from the 0th second to the 4th second during which the first task is executed. For example, the example shown in Table 5 shows that it is possible to capture an image of the workpiece at the 3rd second, while it is not possible to capture images of the starting region, the obstacle, and the destination.

TABLE 5

| | Object | | | |
|---|---|---|---|---|
| Time(s) | Workpiece | Starting region | Obstacle | Destination |
| 0 | x | ∘ | ∘ | ∘ |
| 1 | ∘ | ∘ | ∘ | ∘ |
| 2 | ∘ | ∘ | ∘ | x |
| 3 | ∘ | x | x | x |
| 4 | ∘ | ∘ | x | x |

The control unit may not determine the 1st second at which images of all of the workpiece, the starting region, the obstacle, and the destination can be captured at the same timing as a timing at which a process of acquiring environmental information is executed. That is, the control unit may determine the 4th second as a timing at which images of the workpiece and the starting region are captured, and determine the 1st second as a timing at which images of the obstacle and the destination are captured. By the above configuration, when the first task is being executed, images of objects included in environmental information required for the second task plan can be acquired at different timings for each object.

At this time, when images of a plurality of objects included in environmental information are to be captured at the same timing, the order in which the images of the objects are to be captured can be changed. In the example shown in Table 5, either an image of the workpiece or an image of the starting region may be captured first at the 4th second.

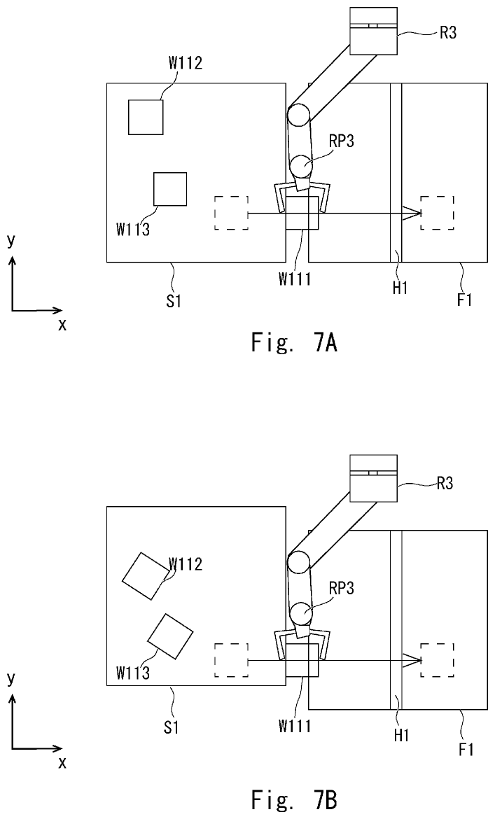

Note that when an error has occurred while the robot is executing the first task, the control unit may execute a process of again acquiring environmental information for generating the second task plan. The descriptions will be given in more detail with reference to FIG. 7.

Each of FIGS. 7A and 7B is a diagram showing objects to be included in environmental information captured by a robot controlled by the robot control system according to the present disclosure. FIG. 7A is a diagram showing objects to be included in environmental information captured by the robot before a person comes into contact with a starting region S1. FIG. 7B is a diagram showing objects to be included in environmental information captured by the robot after a person comes into contact with the starting region S1.

In the example shown in FIG. 7, a robot R3 is executing a task of picking a workpiece W111 using a picking unit RP3 and conveying it from the starting region S1 to a destination F1 while avoiding an obstacle H1. In the example shown in FIG. 7, the robot is moving only the workpiece W111 from the starting region S1 to the destination F1 in a single task. Note that the robot R3 executes a task of conveying the workpieces W111, W112, and W113 from the starting region S1 to the destination F1 while avoiding the obstacle H1.

In the example shown in FIG. 7, the task of conveying the workpiece W111 from the starting region S1 to the destination F1 while avoiding the obstacle H1 corresponds to the first task. The task of conveying the workpiece W112 from the starting region S1 to the destination F1 while avoiding the obstacle H1 corresponds to the second task.

When FIG. 7B is compared with FIG. 7A, the positions of the starting region S1 and the workpieces W12 and W13 are shifted due to a person coming into contact with the starting region S1. In this example, it is assumed that a process of capturing images of the workpiece W112 and the starting region S1 required for the second task plan has been completed at the time when a person comes into contact with the starting region S1.

As shown in FIG. 7B, when a person comes into contact with the starting region S1 during execution of the first task, the positions of the workpiece W112 and the starting region S1 to be captured are shifted. Therefore, an error occurs when the second task is executed. The error is, for example, that the robot R3 cannot pick up the workpiece W112 using the picking unit RP3 since the position of the workpiece W112 is shifted. As another example, the error is that the picking unit RP3 comes into contact with the starting region S1 since the position of the starting region S1 is shifted.

When an error has occurred, the robot control system according to the present disclosure stops the robot R3. At this time, the control unit may notify an administrator that the robot has been stopped since an error has occurred. As a result, the administrator performs a work of repairing the robot manually.

Further, the control unit may execute a process of again acquiring environmental information for generating the second task plan along with notifying an administrator that an error has occurred and the robot has been stopped. More specifically, images of the workpieces W112 and W113, the starting region S1, the destination F1, and the obstacle H1 shown in FIG. 7B are captured again. By doing so, the positions of the objects included in environmental information are updated, and the second task can be executed. As described above, when an error has occurred while the robot is executing the first task, the control unit executes a process of again acquiring environmental information for generating the second task plan. For example, in a 24-hour distribution warehouse or factory, the robot control system according to the present disclosure can be used to operate a factory unattended.

As described above, the robot control system according to the present disclosure determines whether the position of the robot that is executing the first task overlaps an object included in environmental information for generating the second task plan, to thereby determine a timing at which the process of capturing an image of the object included in the environmental information. By doing so, even when a task is being executed, information required for a next task plan can be acquired and then the next task plan can be performed. Therefore, a stop time between tasks can be eliminated. As a result, since the robot can continuously execute tasks, the takt time and the lead time can be reduced, and thus the robot can be operated more efficiently.

Further, some or all of the above-described processes performed by the robot control system according to the above-described first to third example embodiments can be implemented as a computer program.

Note that the program includes instructions (or software codes) that, when loaded into a computer, cause the computer to perform one or more of the functions described in the example embodiments. The program may be stored in a non-transitory computer readable medium or a tangible storage medium.

By way of example, and not a limitation, non-transitory computer readable media or tangible storage media can include a Random-Access Memory (RAM), a Read-Only Memory (ROM), a flash memory, a Solid-State Drive (SSD) or other types of memory technologies, a CD-ROM, a Digital Versatile Disc (DVD), a Blu-ray (Registered Trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Although the present disclosure has been described above with reference to the above example embodiments, the present disclosure is not limited only to the configurations of the above-described example embodiments, and obviously includes various modifications, changes, and combinations that can be made by a person skilled in the art within the scope of the claims of the present application.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

(Supplementary Note 1)

A robot control system for a robot that executes a plurality of tasks including a first task and a subsequent second task respectively based on a first task plan and a second task plan, the robot control system comprising:
an acquisition unit configured to acquire position information indicating a transition of positions of the robot in the first task plan; and
a control unit configured to determine whether or not each of the positions of the robot that is executing the first task specified by the position information interferes with execution of a process of acquiring environmental information for generating the second task plan, to thereby determine a timing at which the process of acquiring the environmental information is executed.

(Supplementary Note 2)

The robot control system according to supplementary note 1, wherein a period during which the position of the robot that is executing the first task does not interfere with execution of a process of acquiring environmental information for generating the second task plan is determined as a timing at which the process of acquiring the environmental information is executed.

(Supplementary Note 3)

The robot control system according to supplementary note 1 or 2, wherein a later timing in a period when the robot is at a position that does not interfere with execution of a process of acquiring environmental information for generating the second task plan is preferentially determined as a timing at which the process of acquiring the environmental information is executed.

(Supplementary Note 4)

The robot control system according to supplementary note 1 or 2, wherein
the process of acquiring the environmental information is a process of capturing an image, and
whether or not each of the positions of the robot that is executing the first task specified by the position information interferes with execution of a process of acquiring environmental information for generating the second task plan depends on whether or not the robot overlaps objects included in the environmental information and thus interferes with the capturing of the objects.

(Supplementary Note 5) The robot control system according to supplementary note 4, wherein
the objects include a plurality of types of objects, and
when the control unit determines that it is possible to acquire the environmental information about one of the plurality of types of objects, the control unit determines the timing at which the control unit determines that it is possible to acquire the environmental information about one of the plurality of types of objects as a timing at which the process of acquiring the environmental information is executed.

(Supplementary Note 6) The robot control system according to supplementary note 5, wherein
the robot executes a task of conveying a workpiece to a destination while avoiding an obstacle, and
the objects include any one or two of the workpiece, the obstacle, and the destination, or all of them.

(Supplementary Note 7) The robot control system according to supplementary note 4, wherein when an error has occurred while the robot is executing the first task, the control unit executes a process of again acquiring the environmental information for generating the second task plan.

(Supplementary Note 8)

A robot control method for controlling a robot that executes a plurality of tasks including a first task and a subsequent second task respectively based on a first task plan and a second task plan, the robot control method comprising:
acquiring position information indicating a transition of positions of the robot in the first task plan; and
determining whether or not each of the positions of the robot that is executing the first task specified by the position information interferes with execution of a process of acquiring environmental information for generating the second task plan; and
determining a timing at which the process of acquiring the environmental information is executed based on a result of the determination.

(Supplementary Note 9)

The robot control method according to supplementary note 8, wherein a period during which the position of the robot that is executing the first task does not interfere with execution of a process of acquiring environmental information for generating the second task plan is determined as a timing at which the process of acquiring the environmental information is executed.

(Supplementary Note 10)

The robot control method according to supplementary note 8 or 9, wherein a later timing in a period when the robot is at a position that does not interfere with execution of a process of acquiring environmental information for generating the second task plan is preferentially determined as a timing at which the process of acquiring the environmental information is executed.

(Supplementary Note 11)

The robot control method according to supplementary note 8 or 9, wherein the process of acquiring the environmental information is a process of capturing an image, and
whether or not each of the positions of the robot that is executing the first task specified by the position information interferes with execution of a process of acquiring environmental information for generating the second task plan depends on whether or not the robot overlaps objects included in the environmental information and thus interferes with the capturing of the objects.

(Supplementary Note 12)

The robot control method according to supplementary note 11, wherein the objects include a plurality of types of objects, and when it is determined that it is possible to acquire the environmental information about one of a plurality of types of objects, the timing at which it is determined that it is possible to acquire the environmental information about one of the plurality of types of objects is determined as a timing at which the process of acquiring the environmental information is executed.

(Supplementary Note 13)

The robot control method according to supplementary note 12, wherein
the robot executes a task of conveying a workpiece to a destination while avoiding an obstacle, and
the objects include any one or two of the workpiece, the obstacle, and the destination, or all of them.

(Supplementary Note 14)

The robot control method according to supplementary note 11, wherein when an error has occurred while the robot is executing the first task, a process of again acquiring the environmental information for generating the second task plan is executed.

(Supplementary Note 15)

A robot control program for a robot that executes a plurality of tasks including a first task and a subsequent second task respectively based on a first task plan and a second task plan, the robot control program causing a computer to execute processing of:
acquiring position information indicating a transition of positions of the robot in the first task plan; and
determining whether or not each of the positions of the robot that is executing the first task specified by the position information interferes with execution of a process of acquiring environmental information for generating the second task plan; and
determining a timing at which the process of acquiring the environmental information is executed based on a result of the determination.

(Supplementary Note 16)

The robot control program according to supplementary note 15, wherein a period during which the position of the robot that is executing the first task does not interfere with execution of a process of acquiring environmental information for generating the second task plan is determined as a timing at which the process of acquiring the environmental information is executed.

(Supplementary Note 17)

The robot control program according to supplementary note 15 or 16, wherein a later timing in a period when the robot is at a position that does not interfere with execution of a process of acquiring environmental information for generating the second task plan is preferentially determined as a timing at which the process of acquiring the environmental information is executed.

(Supplementary Note 18)

The robot control program according to supplementary note 15 or 16, wherein
the process of acquiring the environmental information is a process of capturing an image, and
whether or not each of the positions of the robot that is executing the first task specified by the position information interferes with execution of a process of acquiring environmental information for generating the second task plan depends on whether or not the robot overlaps objects included in the environmental information and thus interferes with the capturing of the objects.

(Supplementary Note 19)

The robot control program according to supplementary note 18, wherein the objects include a plurality of types of objects, and when it is determined that it is possible to acquire the environmental information about one of a plurality of types of objects, the timing at which it is determined that it is possible to acquire the environmental information about one of the plurality of types of objects is determined as a timing at which the process of acquiring the environmental information is executed.

(Supplementary Note 20)

The robot control program according to supplementary note 19, wherein
the robot executes a task of conveying a workpiece to a destination while avoiding an obstacle, and
the objects include any one or two of the workpiece, the obstacle, and the destination, or all of them.

(Supplementary Note 21)

The robot control program according to supplementary note 18, wherein when an error has occurred while the robot is executing the first task, the control unit executes a process of again acquiring the environmental information for generating the second task plan.

What is claimed is:

1. A robot control system for a robot that executes a plurality of tasks including a first task and a subsequent second task respectively based on a first task plan and a second task plan, the robot control system comprising:
at least one memory storing instructions, and
at least one processor configured to execute the instructions to:
acquire position information indicating a transition of positions of the robot in the first task plan; and
determine whether or not each of the positions of the robot that is executing the first task specified by the position information interferes with execution of a process of acquiring environmental information for generating the second task plan, to thereby determine a timing at which the process of acquiring the environmental information is executed.

2. The robot control system according to claim 1, wherein a period during which the position of the robot that is executing the first task does not interfere with execution of a process of acquiring environmental information for generating the second task plan is determined as a timing at which the process of acquiring the environmental information is executed.

3. The robot control system according to claim 1, wherein a later timing in a period when the robot is at a position that does not interfere with execution of a process of acquiring environmental information for generating the second task plan is preferentially determined as a timing at which the process of acquiring the environmental information is executed.

4. The robot control system according to claim 1, wherein
the process of acquiring the environmental information is a process of capturing an image, and
whether or not each of the positions of the robot that is executing the first task specified by the position information interferes with execution of a process of acquiring environmental information for generating the second task plan depends on whether or not the robot overlaps objects included in the environmental information and thus interferes with the capturing of the objects.

5. The robot control system according to claim 4, wherein
the objects include a plurality of types of objects, and
when the at least one processor determines that it is possible to acquire the environmental information about one of the plurality of types of objects, the at least one processor determines the timing at which the at least one processor determines that it is possible to acquire the environmental information about one of the plurality of types of objects as a timing at which the process of acquiring the environmental information is executed.

6. The robot control system according to claim 5, wherein
the robot executes a task of conveying a workpiece to a destination while avoiding an obstacle, and
the objects include any one or two of the workpiece, the obstacle, and the destination, or all of them.

7. The robot control system according to claim 4, wherein when an error has occurred while the robot is executing the first task, the at least one processor executes a process of again acquiring the environmental information for generating the second task plan.

8. A robot control method for controlling a robot that executes a plurality of tasks including a first task and a subsequent second task respectively based on a first task plan and a second task plan, the robot control method comprising:
acquiring position information indicating a transition of positions of the robot in the first task plan; and
determining whether or not each of the positions of the robot that is executing the first task specified by the position information interferes with execution of a process of acquiring environmental information for generating the second task plan; and
determining a timing at which the process of acquiring the environmental information is executed based on a result of the determination.

9. The robot control method according to claim 8, wherein a period during which the position of the robot that is executing the first task does not interfere with execution of a process of acquiring environmental information for generating the second task plan is determined as a timing at which the process of acquiring the environmental information is executed.

10. The robot control method according to claim 8, wherein a later timing in a period when the robot is at a position that does not interfere with execution of a process of acquiring environmental information for generating the second task plan is preferentially determined as a timing at which the process of acquiring the environmental information is executed.

11. The robot control method according to claim 8, wherein
the process of acquiring the environmental information is a process of capturing an image, and
whether or not each of the positions of the robot that is executing the first task specified by the position information interferes with execution of a process of acquiring environmental information for generating the second task plan depends on whether or not the robot overlaps objects included in the environmental information and thus interferes with the capturing of the objects.

12. The robot control method according to claim 11, wherein the objects include a plurality of types of objects, and when it is determined that it is possible to acquire the environmental information about one of a plurality of types of objects, the timing at which it is determined that it is possible to acquire the environmental information about one of the plurality of types of objects is determined as a timing at which the process of acquiring the environmental information is executed.

13. The robot control method according to claim 12, wherein
the robot executes a task of conveying a workpiece to a destination while avoiding an obstacle, and
the objects include any one or two of the workpiece, the obstacle, and the destination, or all of them.

14. The robot control method according to claim 11, wherein when an error has occurred while the robot is executing the first task, a process of again acquiring the environmental information for generating the second task plan is executed.

15. A non-transitory computer readable medium storing a program for a robot that executes a plurality of tasks including a first task and a subsequent second task respectively based on a first task plan and a second task plan, the program causing a computer to execute processing of:
acquiring position information indicating a transition of positions of the robot in the first task plan; and
determining whether or not each of the positions of the robot that is executing the first task specified by the position information interferes with execution of a process of acquiring environmental information for generating the second task plan; and
determining a timing at which the process of acquiring the environmental information is executed based on a result of the determination.

16. The non-transitory computer readable medium according to claim 15, wherein a period during which the position of the robot that is executing the first task does not interfere with execution of a process of acquiring environmental information for generating the second task plan is determined as a timing at which the process of acquiring the environmental information is executed.

17. The non-transitory computer readable medium according to claim 15, wherein a later timing in a period when the robot is at a position that does not interfere with execution of a process of acquiring environmental information for generating the second task plan is preferentially determined as a timing at which the process of acquiring the environmental information is executed.

18. The non-transitory computer readable medium according to claim 15, wherein
the process of acquiring the environmental information is a process of capturing an image, and
whether or not each of the positions of the robot that is executing the first task specified by the position information interferes with execution of a process of acquiring environmental information for generating the second task plan depends on whether or not the robot overlaps objects included in the environmental information and thus interferes with the capturing of the objects.

19. The non-transitory computer readable medium according to claim 18, wherein the objects include a plurality of types of objects, and when it is determined that it is possible to acquire the environmental information about one of a plurality of types of objects, the timing at which it is determined that it is possible to acquire the environmental information about one of the plurality of types of objects is determined as a timing at which the process of acquiring the environmental information is executed.

20. The non-transitory computer readable medium according to claim 19, wherein
the robot executes a task of conveying a workpiece to a destination while avoiding an obstacle, and
the objects include any one or two of the workpiece, the obstacle, and the destination, or all of them.
